(19) United States
(12) Patent Application Publication
(10) Pub. No.: US 2016/0059161 A1
(43) Pub. Date: Mar. 3, 2016

(54) Water Separation System

(71) Applicant: MANN+HUMMEL GMBH, Ludwigsburg (DE)

(72) Inventors: Matthias Heine, Ludwigsburg (DE); Christoph Baumann, Moeglingen (DE); Stefan Fimpel, Ludwigsburg (DE); Lars Spelter, Ditzingen (DE); René Krieger, Stuttgart (DE); Pius Trautmann, Stuttgart (DE)

(21) Appl. No.: 14/831,530

(22) Filed: Aug. 20, 2015

(30) Foreign Application Priority Data
Aug. 26, 2014 (DE) 102014012414.2

(51) Int. Cl. B01D 29/92; B01D 29/90

(52) U.S. Cl. CPC B01D 29/92; B01D 29/90

(57) ABSTRACT

A water separation system for separating water from fuel is provided with a water separator with a separator housing provided with a water collecting chamber; a water separating element arranged in the separator housing and fluidically connected with the water collecting chamber; and a water discharge valve connected to the water collecting chamber. A suction and pressure fuel pump feeds fuel to the water separating element. A control device is operatively connected to the fuel pump to control the fuel pump for discharging water collected in the water collecting chamber such that the fuel pump pumps fuel into the separator housing to displace the collected water and discharge the collected water from the water collecting chamber via the water discharge valve. The water discharge valve is pressure-controlled or transferred into an open position by the control device.

### BACKGROUND OF THE INVENTION

The invention concerns a water separation system for separating water contained in fuel, comprising a first water separator with a separator housing that comprises a fuel inlet and a fuel outlet. The water separator comprises a water separating element arranged in the separator housing and connected fluidically with a first water collecting chamber. A water discharge valve serves for discharging the water that has collected within the first water collecting chamber. The water separation system comprises moreover a fuel pump configured as a suction and pressure pump for feeding the fuel to the water separating element.

The aforementioned water separation systems are used, for example, in motor vehicles with diesel engine in order to protect the high-pressure injection device of the diesel engine or the diesel engine from malfunctions and damages due to the water contained in the fuel. The water separated from the fuel must be discharged from the water collecting chamber at least at intervals. This can be done manually, for example, by means of a water drainage screw that is arranged at the bottom side of the water collecting chamber.

According to another configuration, the separated water is discharged actively from the water collecting chamber. For example, EP 2 026 890 B1 discloses a water separation system with a water separator and a membrane pressure store that can be charged with diesel fuel by means of a fuel pump that is arranged fluidically downstream of the water separator. For discharging the water that is contained in the water collecting chamber, the charged membrane pressure store during operation of the fuel pump is fluidically connected by a valve with the water separator in order to force the diesel fuel that is stored within the membrane pressure store into the water separator. The water collected within the water collecting chamber can thus be displaced out of the water collecting chamber and can be discharged by means of a water discharge valve. This configuration of the water separation system, not only because of the required membrane pressure store, is constructively complex, cost-intensive, and unsuitable for tight mounting conditions.

The invention has therefore the object to provide a water separation system that overall has a simplified and more compact constructive configuration.

### SUMMARY OF THE INVENTION

This object is solved by a water separation system of the afore mentioned kind in that a first water separator is provided that comprises a separator housing with a fuel inlet and a fuel outlet; a water separating element arranged in the separator housing and fluidically connected with a first water collecting chamber; and a water discharge valve for discharging the water from the water collecting chamber. The water separation system further comprises a preferably electrically actuated fuel pump which is embodied as a suction and pressure pump and by means of which the fuel can be fed to the water separating element. The water separation device further comprises a control device that is configured, in particular programmed, to control the fuel pump for discharge of the water collected in the water collecting chamber in such a way that the fuel pump pumps the fuel into the separator housing so that the water collected within the water collecting chamber by displacement by the fuel pumped into the separator housing is discharged from the water collecting chamber via the water discharge valve that is pressure-controlled or transferred into its open position by means of the control device.

Further embodiments of the invention are disclosed in the following description as well as in the dependent claims.

The water separation system according to the invention comprises a more simple constructive configuration in comparison to the prior art. By use of the fuel pump which is designed as a suction and pressure pump, the water can be more quickly discharged from the water collecting chamber than is the case with a passive, i.e., gravity-caused, discharging action of the water. In this way, the interruption of the operational use of the water separation system that is required for water discharge can be kept short. Motor vehicles with diesel combustion engine comprise today in general a high-pressure injection system (e.g., common rail injection) with an upstream (low-pressure) fuel pump which serves for filling or venting the water separator or the high-pressure injection system. This fuel pump can be used in the water separation system according to the invention directly for discharging the separated water from the water collecting chamber of the water separator. In this way, an additional membrane pressure store which is required according to the prior art can be completely dispensed with. The water separation system can therefore be produced overall to be more compact and less expensive and is less susceptible to failure. Retrofitting of the water separation system in existing motor vehicles with an internal combustion engine and the aforementioned fuel pump is in principle possible.

The water discharge valve in the constructively simplest case is pressure-controlled, i.e., is actuatable by the pressure-loaded fuel (media-controlled). The water discharge valve in this case is thus embodied as a pressure relief valve with a defined opening pressure. It is understood that the opening pressure is selected such that it is greater than a maximum operating pressure of the fuel within the separator housing that exists in water separating operation of the water separation system, i.e., with the internal combustion engine running. Alternatively, the water discharge valve of the first water separator can be switchable in a controlled manner by means of the control device between an open position allowing passage of the fuel and a closed position in which the passage of fuel is blocked. The control device in this case is designed or programmed such that it transfers or switches the water discharge valve into the open position for water discharge.

The first water separator according to the invention can be provided with a blocking device by means of which a fuel outflow out of the separator housing is blocked. The blocking device in this context is preferably controllable or activatable by the control device. In other words, the blocking device, actuated by the control device, can be adjusted/switched between through position enabling fuel outflow and a blocking position blocking the fuel outflow. Accordingly, upon pumping in the fuel, pressure loading within the separator that is required for water discharge can be simplified or enabled. In this context, the blocking device, as needed, is correlated with the fuel inlet or fuel outlet of the first water separator.

The fuel pump can be fluidically connected with a connector at the inlet side in particular to the fuel tank and with a connector at the outlet side to the fuel inlet of the separator housing of the first water separator. In this case, the fuel pump in the mounted state in a motor vehicle is arranged between the fuel tank and the first water separator. Inasmuch as between the water separation system and the internal combustion engine a sufficiently large fuel storage volume, optionally with venting device, is available, the water discharge can be optionally performed during operation of the internal combustion engine.

For a low-maintenance or maintenance-free operation of the water separation system, it has been found to be advantageous when the control device comprises a water level sensor (so-called WiF sensor: water-in-fuel sensor) arranged within the water collecting chamber for detecting a water level within the water collecting chamber. In this way, water discharge as a function of the water fill level within the water collecting chamber is enabled. The control device can be in particular designed/programmed such that the water discharge from the first water collecting chamber is performed upon reaching or surpassing a predetermined maximum water fill level in the water collecting chamber of the first water separator.

Diesel absorbs water from the ambient air. Even tiny water proportions in the fuel can damage downstream devices such as piston, cylinder head, injection nozzle, fuel lines, and high-pressure injection pump and negatively affect the performance of the combustion engine. A substantially complete water separation is moreover an important protection from corrosion of the aforementioned engine components. In practice, the available fuels have however a variable water proportion. For an even further improved separation of the water contained in the fuel, the water separation system therefore can be provided according to the invention with a second water separator which is fluidically arranged downstream of the first water separator in the main flow direction of the fuel. The water separation system has thus in this case a twin water separator. For the purpose of a constructive configuration of the water separation system that is as simple as possible, the water collecting chamber of the first water separator can be fluidically connected for water discharge by a connecting line to the second water separator. The water discharge valve of the first water separator is in this case preferably associated with the connecting line or is integrated into the connecting line. It should be noted that the connecting line, regarding a fuel line between the first and the second water separator, is separately embodied and, for example, can be integrated into the separator housing of the first and the second water separator.

The connecting line, according to one embodiment of the invention, can open into the water collecting chamber of the second water separator. This however carries the risk that the water which is supplied via the connecting line breaks through to the fuel outlet of the second water separator and thus to the high-pressure injection system arranged fluidically downstream or to the internal combustion engine. Such a water penetration can cause damage at the injection system or the internal combustion engine (diesel engine).

According to a particularly preferred further embodiment of the invention, the connecting line opens therefore at the raw side into the interior of the separator housing of the second water separator. Considered fluidically, the connecting line thus opens into the separator housing upstream of the water separating element of the second water separator in the main flow direction of the fuel. In this way, it can be ensured that the water, which is discharged from the water collecting chamber of the first water separator, is first separated in the second water separator at the water separating element of the second water separator and precipitates in the water collecting chamber of the second water separator. The aforementioned undesirable penetration of water can therefore be reliably counteracted. According to the invention, water discharge from the second water collecting chamber of the second water separator can be realized manually, for example, by means of a generally known water drainage screw, but also automatically, for example, by means of a second water discharge valve which can be actuated by the control device.

In regard to constructive considerations as well as in regard to cost considerations, it has been found to be particularly advantageous in case of the aforementioned twin water separator when the fuel pump is arranged fluidically between the first water separator and the second water separator. The fuel pump is in this case embodied as a bidirectionally functioning fuel pump. In other words, the pump can convey (pump) the fuel in both direction, i.e., in the main flow direction of the fuel and in a direction opposite to the main flow direction.

The control device is designed or programmed to control the fuel pump for discharging the water from the water collecting chamber of the first water separator in such a way that the pump pumps back the fuel in a direction opposite to the main flow direction of the fuel from the second water separator to the first water separator. The aforementioned blocking device of the first water separator, by means of which outflow of the fuel out of the first water separator can be prevented, is in this case preferably associated with the fuel inlet of the first water separator or is fluidically arranged upstream in the main flow direction of the fuel. Return flow of the fuel in the direction of a fuel tank can thus be prevented reliably. For this case, the blocking device can also be embodied as a pressure-actuated valve, in particular as a check valve preventing return flow into the fuel tank which in normal operation opens for the fuel flowing into the fuel inlet and closes in opposite direction. Control of the valve by the control device is not required in this case. Pressure build-up in the interior of the separator housing of the first water separator which is required for discharging the water from the water collecting chamber of the first water separator can thus be ensured.

According to the invention, for avoiding recirculation of water from the second water separator into the first water separator upon water discharge, the fuel pump can be fluidically connected by means of a (fuel) return line with the clean side or the fuel outlet at the clean side of the second water separator.

The water separating element of the first and/or the second water separator can comprise a particle filter medium for separation of particulate contaminants from the fuel. In this way, damage of the components which are fluidically downstream of the water separation system, for example, the aforementioned injection pump, the injection nozzles, and the internal combustion engine can be reliably counteracted.

### BRIEF DESCRIPTION OF THE DRAWINGS

The invention will be explained in the following in more detail with the aid of embodiments illustrated in the drawings.

FIG. 1 is a block diagram of a first embodiment of a water separation system.

FIG. 2 is a block diagram of a second embodiment of the water separation system with two serially arranged water separators.

FIG. 3 shows the water separation system of FIG. 2 in normal operation in a sectioned detail view.

FIG. 4 shows the water separation system according to FIG. 3 during water discharge from a first one of the two water separators.

FIG. 5 is a block diagram of a further embodiment of the water separation system.

### DESCRIPTION OF PREFERRED EMBODIMENTS

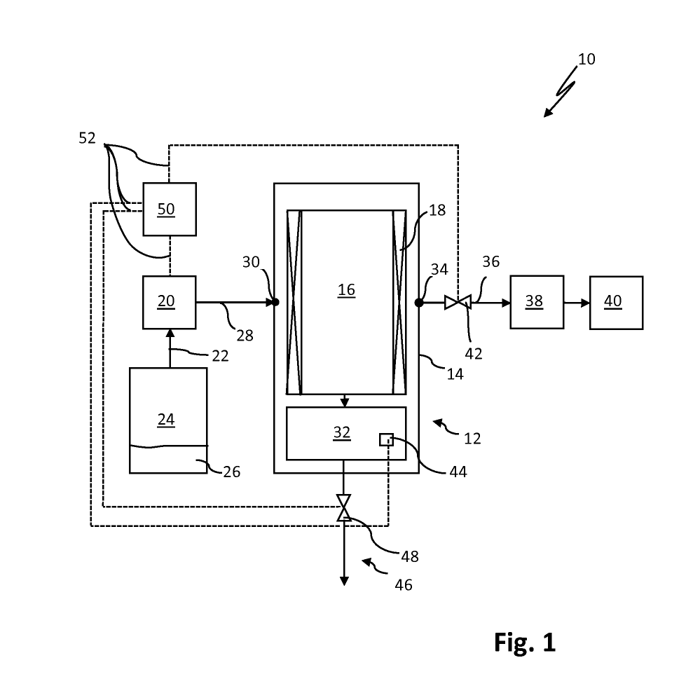

FIG. 1 shows a diagram of a water separation system 10 for water contained in fuel, in particular diesel fuel. The water separation system 10 can be used in particular in motor vehicles with an internal combustion engine and high-pressure injection.

The water separation system 10 comprises a first water separator 12 with a first separator housing 14 and with a first water separating element 16 arranged therein. The water separating element 16 can comprise a particle filter medium 18 for additional separation of dirt particles contained in the fuel.

A fuel pump 20 which is designed as a suction and pressure pump serves to pump the fuel to the water separator 12 or the water separating element 16. For this purpose, the fuel pump 20 is fluidically connected by means of a first fuel line 22 with a fuel tank 24 in which the fuel 26 is stored. The fuel pump 20 has a connector at the outlet side that is connected by means of a second fuel line 28 with a fuel inlet 30 of the water separator 12 by means of which the fuel 26 passes into the interior of the separator housing 14. The fuel pump 20 is thus arranged fluidically between the fuel tank 24 and the water separator 12.

At the water separating element 16 at least a portion of the water contained in the fuel 26 is separated from the fuel 26. The water settles, following the force of gravity, in the separator housing 14 within a water collecting chamber 32. The water collecting chamber 32 is thus fluidically connected with the water separating element 16 and in operational use of the water separation system 10 is arranged underneath the water separating element 16. In the illustrated embodiment, the water collecting chamber 32 is arranged, for example, within the separator housing 14. It is understood that the water collecting chamber 32 can also be arranged outside of the separator housing 14.

The separator housing 14 comprises a fuel outlet 34 for the fuel 26 from which water has been removed at least partially. To the fuel outlet 34 a third fuel line 36 is connected. The third fuel line 36 is fluidically connected with a high-pressure injection system 38 of an internal combustion engine 40, here a diesel engine. A controllable blocking device 42, illustrated in FIG. 1, can serve for interrupting a fuel outflow via the fuel outlet 34 of the first water separator 12. The blocking device 42 is designed in an exemplary fashion as a check valve.

In the water collecting chamber 32 of the water separator 12, a water level sensor (so-called WiF sensor) 44 is arranged by means of which a water fill level (water level) in the water collecting chamber 32 can be detected.

A water discharge device 46 with a water discharge valve 48 serves for discharging the water collected within the water collecting chamber 32.

The water separation system 10 comprises a control device 50 for controlled water discharge from the water collecting chamber 32 of the water separator 12. The control device 50 is coupled by means of control or data lines 52, shown in dash-dotted lines, with the water level sensor 44, the fuel pump 20, the water discharge valve 48, and the blocking device 42, if present.

The control device 50 is programmed to open, based on the sensor information of the water level sensor 44, in particular when a predetermined maximum water fill level (not identified) in the water collecting chamber 32 is reached, the water discharge valve 48 for discharging the water collected within the water collecting chamber 32 and to activate the blocking device 42 as well as, with activated blocking device 42, to pump the fuel 26 into the separator housing 14 by means of the fuel pump 20 through the fuel inlet 30 of the separator housing 14 in order to displace in this way the water collected within the water collecting chamber 32 and to discharge it through the open water discharge valve 48 from the water collecting chamber 32.

According to a further embodiment of the invention, the water discharge valve 48 can also be embodied as a media-controlled actuatable pressure relief valve. A control of the water discharge valve 48 by means of the control device 50 is then not required. The water discharge valve 48 comprises in this case a predetermined opening pressure (not identified) that is greater than a fuel pressure which is acting in the separator housing 14 under normal operating conditions. The opening pressure of the fuel 26 which is required for opening the water discharge valve 48 can be built up within the separator housing 14 by means of the fuel pump 20 when the blocking device 42 is activated.

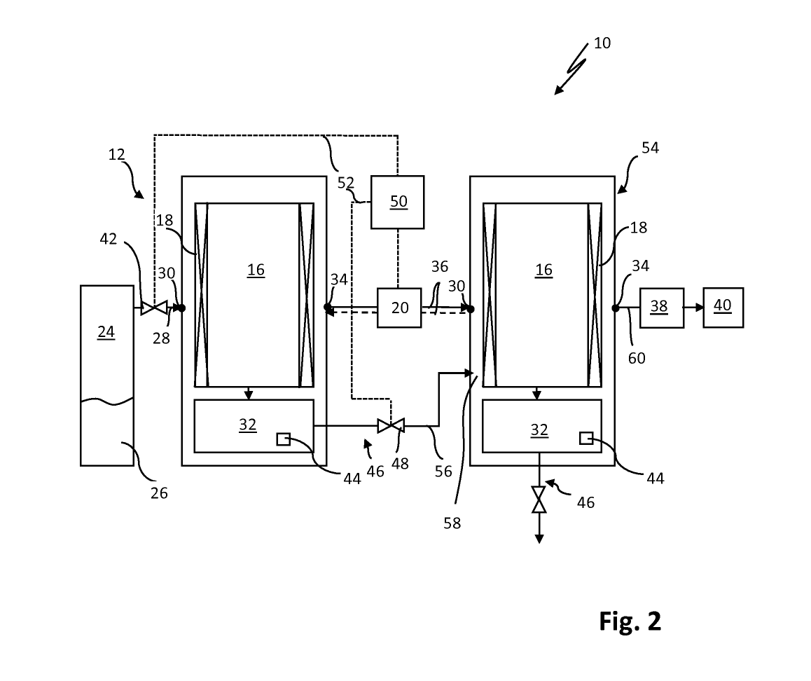

In FIG. 2, the block diagram of a water separation system 10 is illustrated which, in comparison to the water separation system 10 illustrated in FIG. 1, comprises a second water separator 54 which is arranged fluidically downstream of the first water separator 12 in the main flow direction of the fuel 26. The two water separators 12, 54 are thus fluidically connected in series. The first water separator 12 functions in this case as a pre-separator while the second water separator 54 functions as main separator. The second water separator 54 can be designed so as to correspond constructively to the first water separator 12.

In the present case, the third fuel line 36 is fluidically connected at the outlet side of the fuel pump 20 with the fuel inlet 30 of the second separator housing 14 of the second water separator 54. The water separation system 10 comprises a connecting channel or a connecting line 56 which fluidically connects the first water collecting chamber 32 of the first water separator 12 with a raw side 58 of the second water separator 54. The raw side 58 is fluidically arranged upstream of the second water separating element 16 of the second water separator 54 (in main flow direction of the fuel 26). The connecting line 56 is provided with the first water discharge valve 48. The first water discharge valve 48 can be embodied as a media-actuated one-way valve. In normal operation of the water separation system, an undesirable return flow of fuel 26 or water from the second water separator 54 to the first water separator 12 via the connecting line 56 can be prevented in this way. The fuel outlet 34 of the second separator housing 14 of the second water separator 54 is fluidically connected by a fourth fuel line 60 in an exemplary fashion with the high-pressure injection system 38 of the internal combustion engine 40.

The fuel pump 20 is designed as a suction and pressure pump and is fluidically intermediately connected between the first water separator 12 and the second water separator 54. The fuel pump 20 in this context is designed as a bidirectionally conveying pump, i.e., the fuel pump 20 can pump the fuel 26 in normal operating state along the main flow direction of the fuel 26 from the first water separator 12 to the second water separator 54 and, in a water discharge operating state, can pump the fuel 26 back in a direction opposite to the main flow direction from the second water separator 54 to the first water separator 12.

The control device 50 controls the water discharge from the first water collecting chamber 32 of the first water separator 12. For this purpose, the control device 50 is programmed to activate the blocking device 42 upon reaching the maximum water fill level in the first water collecting chamber 32 and to switch the fuel pump 20 from its normal operating state into the water discharge operating state and, when the blocking device 42 is activated, to pump the fuel 26 contained within the second water separator 54 by means of the fuel pump 20 into the first separator housing 14 in order to discharge the water, collected in the water collecting chamber of the first water separator 12. Discharge of the water is realized by displacement by means of the fuel 26 which is pumped into the separator housing 14 of the first water separator 12. The water is discharged from the water collecting chamber 32 via the connecting line 56 as well as via the water discharge valve 48. In this context, the discharged water is forced into the second water separator 54 at the raw side 58 of the second water separator 54 and is separated by means of the second water separating element 16 of the second water separator 54 into the water collecting chamber 32 of the second water separator 54. This circulation of the fuel 26 or of the separated water between the second and the first water separators 54, 12 is carried out with constant volume, i.e., a volume compensation, for example, by means of a venting device, is not necessarily required. Accordingly, the necessity of degassing the water separation system 10 after discharge of water from the first water collecting chamber 32 of the first water separator 12 can be dispensed with.

The control device 50 controls the fuel volume pumped back by the fuel pump 20 into the first water separator 12 and required for displacement, i.e., for discharge, of the water from the first water collecting chamber 32 of the first water separator 12. This can be realized in case of a known pump capacity of the fuel pump 20, for example, by time control or based on measuring signals of the water level sensor 44 of the first water separator 12. The second water discharge device 46 with water discharge valve of the second water separator 54 can be actuatable manually or by activation by the control device 50.

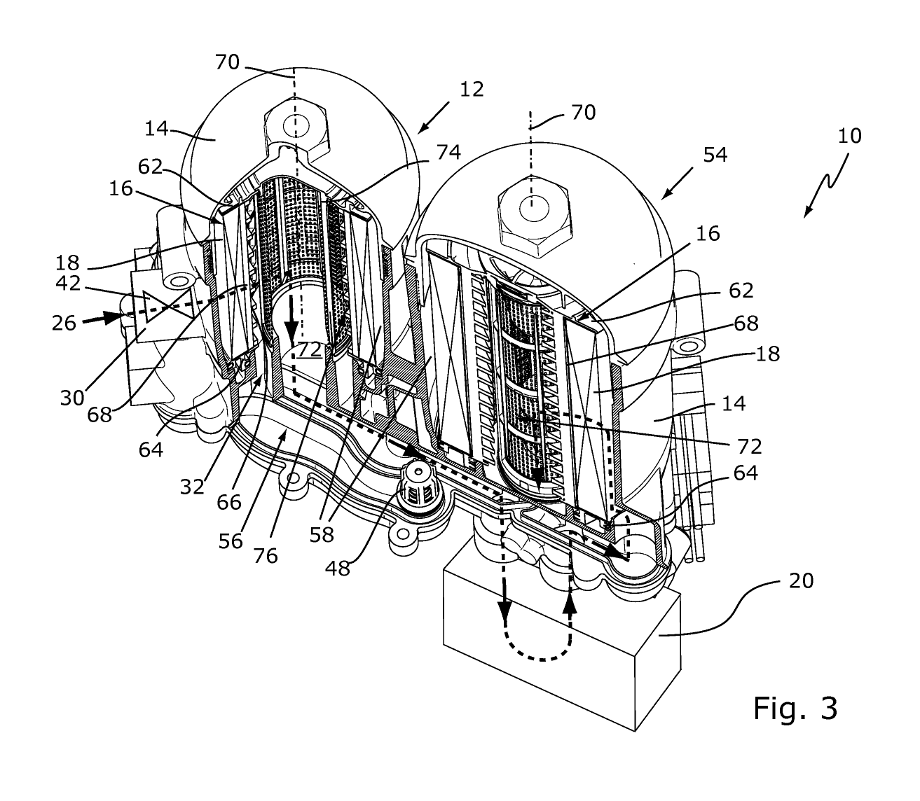

In FIG. 3, the water separation system 10 of FIG. 2 is illustrated in a partial sectioned view. As can be seen in FIG. 3, the first and second water separating elements 16 of the first and second water separators 12, 54 each comprise an upper and a lower end disk 62, 64 that are connected to each other by a screen-like central tube 66. A particle filter medium 18 is arranged in an annular shape about the central tube 66. The particle filter medium 18 can be folded in a star shape and is embedded at both ends fluid-tightly in the two end disks 62, 64. The particle filter medium 18 is supported on the central tube 66 by a single-layer or multi-layer coalescing medium 68 that is surrounding the central tube 66 annularly. In the normal operating state of the fuel pump 20, the particle filter medium 18 as well as the coalescing medium 68 are flowed through by the fuel 26 in a radial direction relative to the respective longitudinal axis 70 of the water separating element 16 from the exterior to the interior. The lower end disks 64 are resting seal-tightly on the respective separator housing 14 of the first and the second water separator 12, 54 and seal the raw side 58 of the water separator 12, 54 relative to a clean side 72 of the water separator 12, 54, respectively.

Within the two central tubes 66 a screen pipe 74 is arranged, respectively. Between the central tube 66 and the screen pipe 74, a water separating gap 76 is formed which is downwardly open. The water separating gap 76 is in fluidic communication with the water collecting chamber (compare FIG. 2) of the respective water separator 12, 54. The water discharge valve 48 of the connecting line 56 can be seen well in FIG. 3. The separator housing 14 of the two water separators 12, 54 can be designed to be openable in order to enable exchange of the two water separating elements 16.

The main flow direction of the fuel 26 in normal operation of the water separation system 10 is indicated clearly with the arrow-shaped dash-dotted line. In this context, the fuel 26 flows preferably through the fuel inlet 30 and the blocking device 42 which is arranged on or in the fuel inlet 30, for example, a valve which is controllable by means of the control device 50 or a check valve, into the first water separator 12.

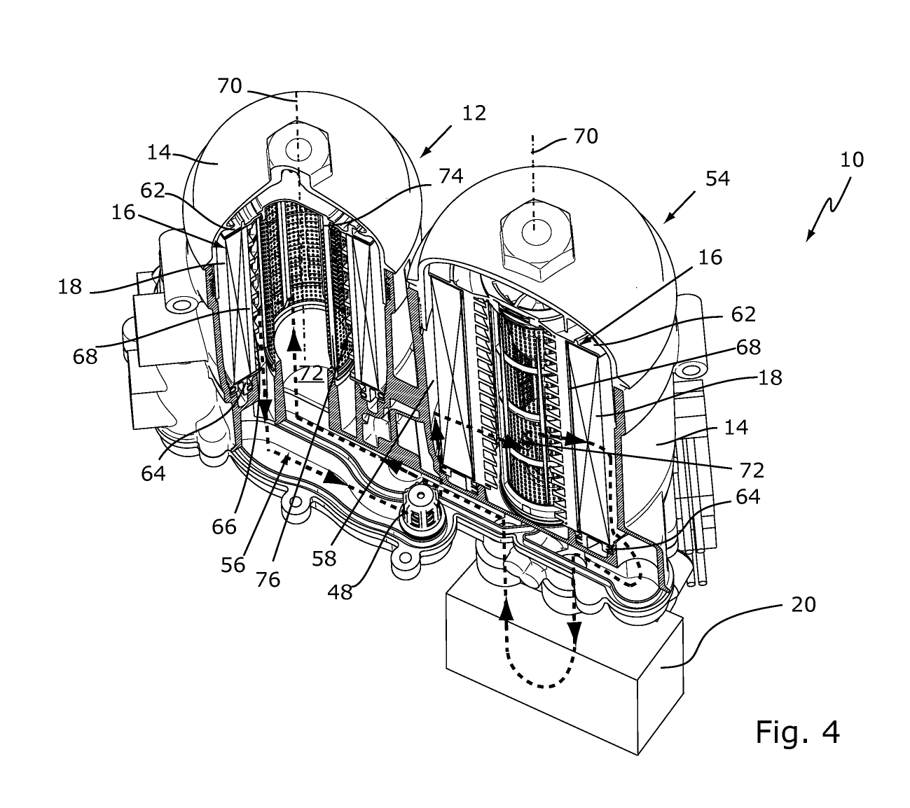

In FIG. 4, the water separation system 10 of FIG. 3 is illustrated during water discharge from the first water collecting chamber 32 of the first water separator 12. The blocking device 42 (not shown here) prevents preferably the return flow of fuel 26 from the first water separator 12 through the fuel inlet 30. The fuel 26 is pumped back by the fuel pump 20, which is switched into the water discharge operating state, opposite to the main flow direction illustrated in FIG. 3 from the second water separator 54 to the first water separator 12, as is illustrated by the arrow-shaped dash-dotted line. The water collected within the first water collecting chamber 32 of the first water separator 12 flows, optionally with fuel (admixture) 26, through the connecting line 56 which is provided with the first water discharge valve 48 to the raw side 58 of the second water separator 54 and is separated thereat at the second water separating element 16 of the second water separator 54 into the second water collecting chamber 32 of the second water separator 54. The connecting line 56 opens preferably axially spaced from the fuel inlet 30 of the second water separator 54 into the interior of the second separator housing 14 in order to counteract an undesirable circulation of the water between the second and the first water separators 54, 12.

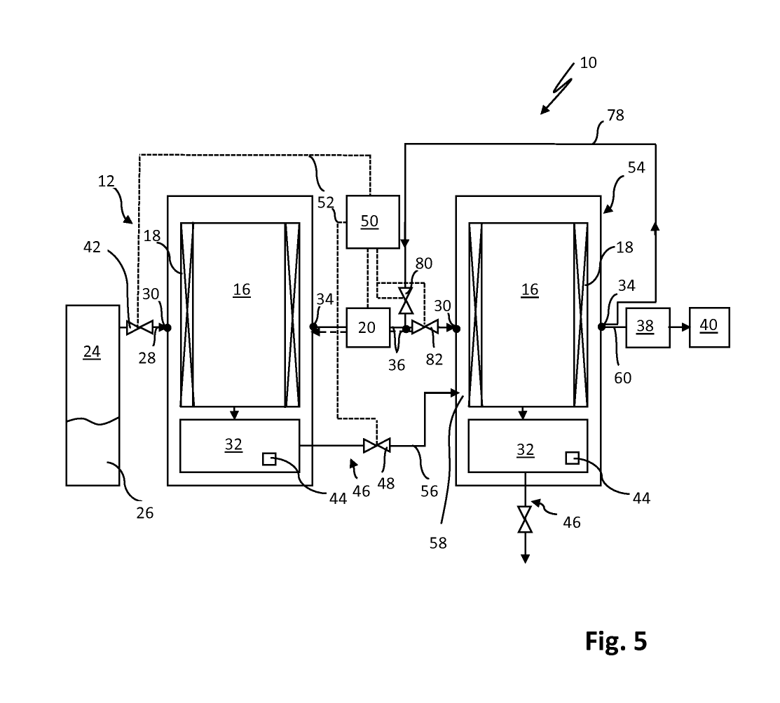

In FIG. 5, a block diagram of a further embodiment of the water separation system 10 is shown which differs from the water separation system illustrated in FIG. 2 substantially in that the fuel pump 20 which is embodied as a suction and pressure pump is connected fluidically by means of an additional return line 78 with the fuel outlet 34 of the second water separator 54 arranged at the clean side. The return line 78 is provided with a first check valve 80 that is actuatable (switchable) by the control device. The fourth fuel line can be separated fluidically by a second check valve 82 actuated by the control device 50 from the fuel inlet 30 of the second water separator 54. The second check valve 82 is not required provided that the first check valve 80 is embodied as a three-way valve, for example. For water discharge from the first water collecting chamber 32 of the first water separator 12, the control device 50 is programmed to perform the following steps:
activation of the blocking device 42;
opening the first check valve 80 in order to fluidically connect the fuel pump 20 by means of the return line 78 with the fuel outlet 34 of the second water separator 54;
fluidically separating the fuel pump 20 from the fuel inlet 30 of the second water separator 54 by transferring the second check valve 82 into its closed position;
opening the first water discharge valve 48 of the first water separator 12;
transferring the fuel pump 20 into its water discharge operating state in order to pump the fuel 26 from the clean side of the second water separator 54 via the return line 78 into the first water separator 12 and to thereby discharge the water from the first water collecting chamber 32 of the first water separator 12 via the first water discharge valve 48 into the second water separator 54.

While specific embodiments of the invention have been shown and described in detail to illustrate the inventive principles, it will be understood that the invention may be embodied otherwise without departing from such principles.

What is claimed is:

1. A water separation system for separating water contained in fuel, the water separation system comprising:
a first water separator comprising:
a first separator housing comprising a fuel inlet and a fuel outlet;
a first water collecting chamber;
a first water separating element arranged in the separator housing and fluidically connected with the first water collecting chamber;
a first water discharge valve connected to the first water collecting chamber;
a fuel pump embodied as a suction and pressure pump and configured to feed fuel to the first water separating element;
a control device operatively connected to the fuel pump to control the fuel pump for discharging water collected in the first water collecting chamber such that the fuel pump pumps fuel into the first separator housing to displace the water collected within the first water collecting chamber from the first water collecting chamber and discharge the water from the first water collecting chamber via the first water discharge valve, wherein the first water discharge valve is pressure-controlled or transferred into an open position by the control device.

2. The water separation system according to claim 1, wherein the control device is programmed to control the fuel pump.

3. The water separation system according to claim 1, wherein the fuel pump is electrically actuated.

4. The water separation system according to claim 1, further comprising a blocking device, wherein the control device is operatively connected to the blocking device and the blocking device is configured to be actuated by the control device, wherein the blocking device in a blocking position blocks fuel outflow from the first separator housing.

5. The water separation system according to claim 1, wherein the fuel pump comprises an inlet side and an outlet side, wherein the inlet side of the fuel pump is fluidically connected to a fuel tank and the outlet side of the fuel pump is connected to the fuel inlet of the first separator housing.

6. The water separation system according to claim 1, wherein the control device comprises a water level sensor arranged in the first water collecting chamber.

7. The water separation system according to claim 1, further comprising:
a second water separator fluidically connected to the first water separator downstream of the first water separator in a main flow direction of the fuel, wherein the second water separator comprises a second separator housing and a second separating element arranged in the second separator housing; and
a connecting line fluidically connecting the first water collecting chamber of the first water separator to the second water separator.

8. The water separation system according to claim 7, wherein the connecting line is connected to a raw side of the second water separator and wherein the first water discharge valve is arranged in the connecting line.

9. The water separation system according to claim 7, wherein the fuel pump is connected fluidically between the first water separator and the second water separator, wherein the control device is configured to actuate the fuel pump for discharging the water from the first water collecting chamber such that the fuel pump pumps back the fuel opposite to the main flow direction of the fuel from the second water separator to the first water separator.

10. The water separation system according to claim 9, further comprising a return line connecting fluidically a clean side of the second water separator to the fuel pump.

11. The water separation system according to claim 7, wherein the second water separator comprises a second water collecting chamber fluidically connected to the second water separating element and further comprises a second water discharge valve connected to the second water collecting chamber.

12. The water separation system according to claim 7, wherein the second water separating element of the second water separator comprises a particle filter medium for separating particulate contaminants from the fuel.

13. The water separation system according to claim 12, wherein the second water separating element of the second water separator comprises a coalescing medium.

14. The water separation system according to claim 7, wherein the second water separating element of the second water separator comprises a coalescing medium.

15. The water separation system according to claim 1, wherein the first water separating element of the first water separator comprises a particle filter medium for separating particulate contaminants from the fuel.

16. The water separation system according to claim 15, wherein the first water separating element of the first water separator comprises a coalescing medium.

17. The water separation system according to claim 1, wherein the first water separating element of the first water separator comprises a coalescing medium.
